(19) United States
(12) Patent Application Publication
(10) Pub. No.: US 2002/0118407 A1
(43) Pub. Date: Aug. 29, 2002

(54) Solid-state image pickup apparatus and method for driving the same

(76) Inventors: Hiroyoshi Komobuchi, Kyoto-shi (JP); Yasuhiro Morinaka, Kadoma-shi (JP); Toshiya Fujii, Otsu-shi (JP); Kazuyuki Inokuma, Yawata-shi (JP)

Correspondence Address: HARNESS, DICKEY & PIERCE, P.L.C., P.O. BOX 828, BLOOMFIELD HILLS, MI, 48303, US

(21) Appl. No.: 10/084,123

(22) Filed: Feb. 27, 2002

(30) Foreign Application Priority Data
Feb. 28, 2001 (JP) 2001-053,555

(51) Int. Cl. H04N 1/46

(52) U.S. Cl. 358/513

(57) ABSTRACT

The solid-state image pickup device permitting parallel readout having an image pickup section partitioned into strip blocks and a readout amplifier for each block further has: an input source; and a marker signal generation section for generating marker signals for correction of outputs of the readout amplifiers. The marker signal generation section has a marker charge storage portion made of capacitors for respectively storing an amount of charge corresponding to the potential at the input source. The marker signals having a same charge amount generated in the marker signal generation section are read through vertical CCDs of two adjacent blocks and corresponding horizontal CCDs and readout amplifiers sequentially.

### BACKGROUND OF THE INVENTION

The present invention relates to a solid-state image pickup apparatus allowing parallel readout with an image pickup section partitioned into blocks, and a method for driving such a solid-state image pickup apparatus.

In the field of security and the field of digital still cameras, parallel readout type solid-state image pickup apparatuses have been sought for simultaneous achievement of high-definition image pickup and high-speed readout. In this type of image pickup apparatuses, correction of a variation among a plurality of outputs is required.

As a prior art example of use of a plurality of horizontal charge-coupled devices (CCDs) to achieve high-speed readout, known is a parallel readout type solid-state image pickup disclosed in U.S. Pat. No. 4,598,321 (Prior art 1, issued on Jul. 1, 1986). As prior art methods for correcting a variation among output signals, known are Japanese Laid-Open Patent Publication No. 2-78382 (Prior art 2, published on Mar. 19, 1990) and Japanese Laid-Open Patent Publication No. 4-96480 (Prior art 3, published on Mar. 27, 1992).

In the technique described in Prior art 1, signal charge is directed to the two ends of a horizontal CCD from the center thereof, that is, transferred in the opposing directions. The readout positions are therefore limited to the four corners at maximum, and thus higher speed by further partitioning is no more attained.

Prior arts 2 and 3 describe correction of output characteristics of two or more horizontal CCD channels. In these prior arts, however, the horizontal CCD has a structure of a plurality of channels arranged in the vertical transfer direction, so that charge transfer in the vertical direction is also allowed in the horizontal CCD, which essentially should perform charge transfer only in the horizontal direction. Due to this structure, the horizontal CCD tends to generate transfer degradation, which is known to cause a problem in practical use.

If the image pickup section is partitioned into strip blocks and horizontal CCDs are provided for the respective blocks to enable parallel output, the number of horizontal transfer steps can be reduced while the time-tested basic structure is maintained, and therefore the operation speed will improve. However, correction of a variation among output signals is not possible by the techniques described in Prior arts 2 and 3.

### SUMMARY OF THE INVENTION

An object of the present invention is providing a solid-state image pickup apparatus in which a correction signal for making reproduced images uniform among blocks (hereinafter, such a signal is called a marker signal) is generated in a marker signal generation section for correcting a variation in output characteristics among the blocks using the marker signal, and a method for driving such a solid-state image pickup apparatus.

According to the present invention, the solid-state image pickup apparatus permitting parallel readout includes an image pickup section partitioned into blocks and a readout amplifier for each block. The apparatus further includes: a marker signal source for supplying a required amount of charge; and a marker signal generation section for generating marker signals having a same charge amount to be sent into two adjacent blocks of the image pickup section from the charge supplied from the marker signal source, wherein each of the blocks of the image pickup section transfers the marker signal sent from the marker signal generation section so that the marker signal is read out via the readout amplifier for the block for correction of an output of the readout amplifier.

For example, in a solid-state image pickup apparatus allowing parallel readout with an image pickup section partitioned into strip blocks, a marker signal generation section is placed upstream of the image pickup section. Marker signals generated in the marker signal generation section are read from horizontal CCDs placed downstream of the blocks via the image pickup section.

According to the present invention, marker signals having a same charge amount are read as outputs of adjacent blocks alternately at a frame period or a field period, or even at a period shorter than the latter period. Using these marker signals, a variation among the input/output characteristics of amplifiers is calibrated by a correction circuit at a downstream stage, and thus boundaries between blocks are avoided from becoming noticeable.

### BRIEF DESCRIPTION OF THE DRAWINGS

FIG. 1 is a plan view of a configuration of an image pickup device of a solid-state image pickup apparatus of the present invention.

FIG. 2 is an equivalent circuit diagram of a readout amplifier in FIG. 1.

FIG. 3A is an enlarged plan view of one phase gate at a marker charge storage portion in FIG. 1.

FIG. 3B is a plan view of other two phase gates formed on the one phase gate in FIG. 3A.

FIG. 3C is a plan view of yet another one phase gate formed on the two phase gates in FIG. 3B.

FIG. 4 is a timing chart for depicting a method of generating a marker signal in the solid-state image pickup device of FIG. 1.

FIG. 5A is a potential diagram of vertical CCDs corresponding to the timing chart of FIG. 4.

FIG. 5B is a continuation of the potential diagram of FIG. 5A.

FIG. 6 is a potential diagram for depicting a method of adding a plurality of marker signals each having a unit charge amount in the vertical CCDs of the solid-state image pickup device of FIG. 1.

FIG. 7 shows output characteristics of a plurality of marker signals generated by the method depicted in FIG. 6.

FIG. 8 is a timing chart for depicting a method of generating a marker signal using the addition method depicted in FIG. 6.

FIG. 9A is a potential diagram of the vertical CCDs corresponding to the timing chart of FIG. 8.

FIG. 9B is a continuation of the potential diagram of FIG. 9A.

FIG. 10 is a potential diagram showing that the charge amount of a marker signal in the vertical CCDs can be controlled by changing the potential at an input source in FIG. 1.

FIG. 11 is a plan view of a configuration adopted to generate a plurality of marker signals having different charge amounts simultaneously in one block in FIG. 1.

FIG. 12 is a block diagram of an entire configuration of the solid-state image pickup apparatus of the present invention.

FIG. 13 is a view representing a method of correcting the outputs of readout amplifiers of the solid-state image pickup apparatus of FIG. 12.

FIG. 14 is a plan view of another configuration of an image pickup device of the solid-state image pickup apparatus of the present invention.

FIG. 15A is an enlarged plan view of impurity injection portions for formation of vertical CCDs in FIG. 14.

FIG. 15B is a plan view of multi-phase gates formed on the impurity injection portions in FIG. 15A.

FIG. 15C is a plan view of other multi-phase gates formed on the multi-phase gates in FIG. 15B.

FIG. 16 is a timing chart for depicting a method of generating a marker signal in the solid-state image pickup device of FIG. 14.

FIG. 17A is a potential diagram of vertical CCDs corresponding to the timing chart of FIG. 16.

FIG. 17B is a continuation of the potential diagram of FIG. 17A.

### DESCRIPTION OF THE PREFERRED EMBODIMENTS

Hereinafter, an embodiment of the present invention will be described with reference to the accompanying drawings.

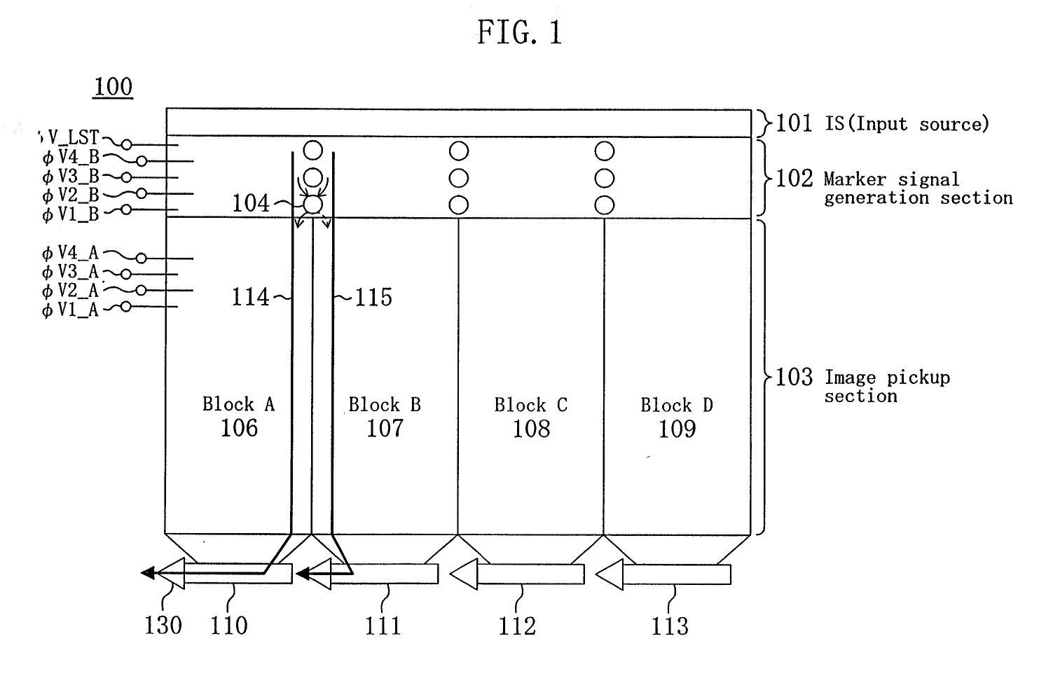

FIG. 1 illustrates an image pickup device of a solid-state image pickup apparatus of the present invention, which has a four-block parallel-output configuration using CCDs. The solid-state image pickup device of FIG. 1, denoted by the reference numeral 100, includes an input source (IS) 101, a marker signal generation section 102, marker charge storage portions (capacitors) 104, blocks A to D (106 to 109) constituting an image pickup section 103, horizontal CCDs 110 to 113, and readout amplifiers (signal charge detectors) 130. The marker signal generation section 102 is essentially composed of the marker charge storage portions 104 and part of vertical CCDs 114, 115. The input source 101 serves as a marker signal source for supplying a required amount of charge to the marker signal generation section 102. Marker signals are generated in the marker signal generation section 102 at each boundary between adjacent blocks, and the generated marker signals are cyclically distributed to either of the adjacent two blocks.

As shown in FIG. 1, the input source 101 is formed to have pn junction on the top ends of the vertical CCDs 114, 115 of the marker signal generation section 102. By controlling a voltage applied to one of impurity layers of the pn junction, the charge amount allowed to flow into the vertical CCDs 114, 115 is controlled. In the portion of the marker signal generation section 102 near the boundary between the blocks A and B of the image pickup section 103, the marker charge storage portion 104, corresponding to a photo diode (PD) of the image pickup section 103, stores a marker signal temporarily and sends it out by unit of field or frame to the right and left blocks alternately.

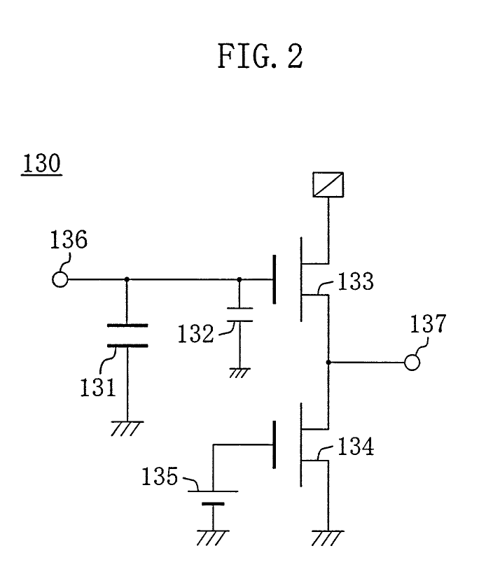

FIG. 2 is an equivalent circuit diagram of the readout amplifier 130 in FIG. 1, showing a floating diffusion amplifier (FDA) generally used as a readout amplifier for a horizontal CCD, together with a source follower thereof. The readout amplifier 130 is essentially composed of a detection capacitance 131, a parasitic capacitance 132, a drive transistor 133, a load transistor 134, a gate voltage 135, an input terminal 136, and an output terminal 137. The readout amplifiers 130 vary in input/output characteristics even when the same design conditions and the same process are adopted. There are various causes for the variation, including a variation in the detection capacitance 131 itself, a variation in the parasitic capacitance 132 relating to interconnections, and a variation in the mutual conductance value (gm) of the source follower (the drive transistor 133, the load transistor 134, and the gate voltage 135). It is therefore difficult to eliminate all of these causes completely and realize uniform input/output characteristics. In consideration of the above, for calibration of absolute values among the readout amplifiers, it is required to generate a marker signal having a known signal charge amount in the marker signal generation section 102 and correct the input/output characteristics of the readout amplifiers 130 using the marker signal.

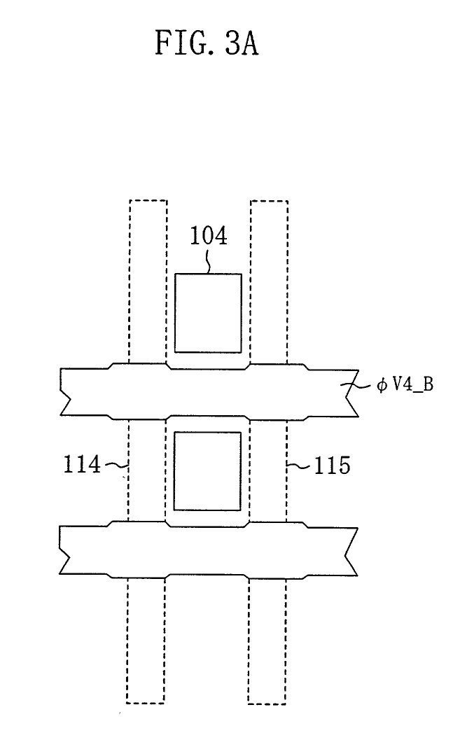

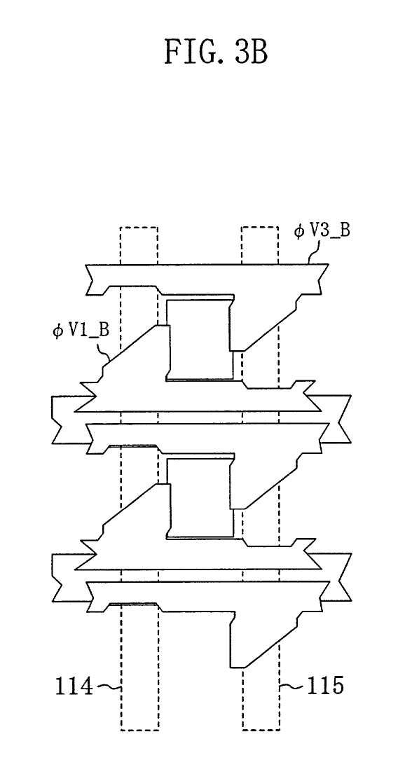

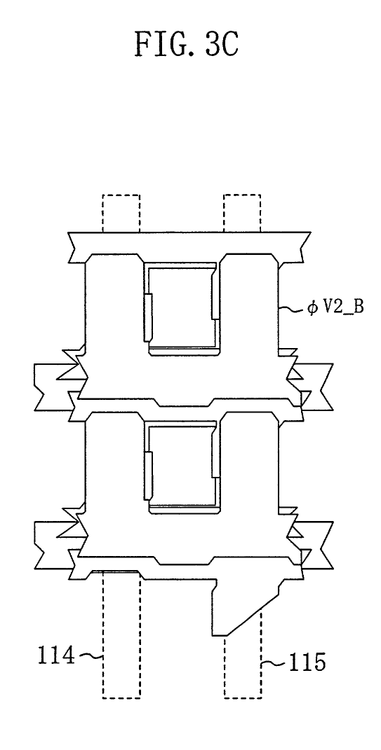

FIGS. 3A to 3C illustrate a process of formation of four phase gates φ V4_B, φ V3_B, φ V2_B and φ V1_B at the marker charge storage portion 104 in FIG. 1, in which φ V4_B is made of polysilicon of the first layer, φ V3_B and φ V1_B are made of polysilicon of the second layer, and V2_B is made of polysilicon of the third layer. Among these gates, φ V3_B and φ V1_B are gates controlling flow of charge from the vertical CCDs 114, 115 to the marker charge storage portion 104 and flow of charge from the marker charge storage portion 104 to the vertical CCDs 114, 115. Although not illustrated, the marker charge storage portion 104 is covered with a metal light-shading film at the top to block influence of incident light.

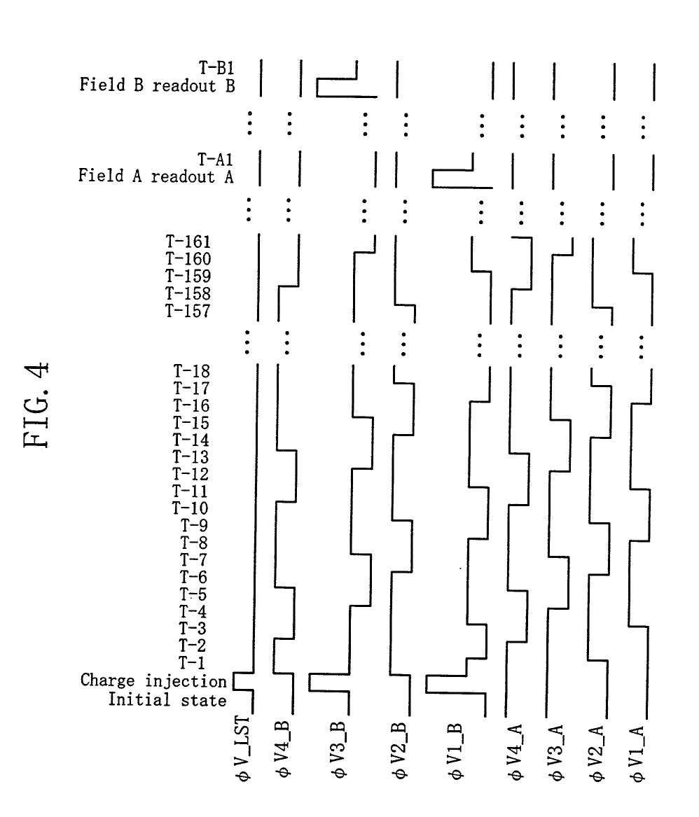

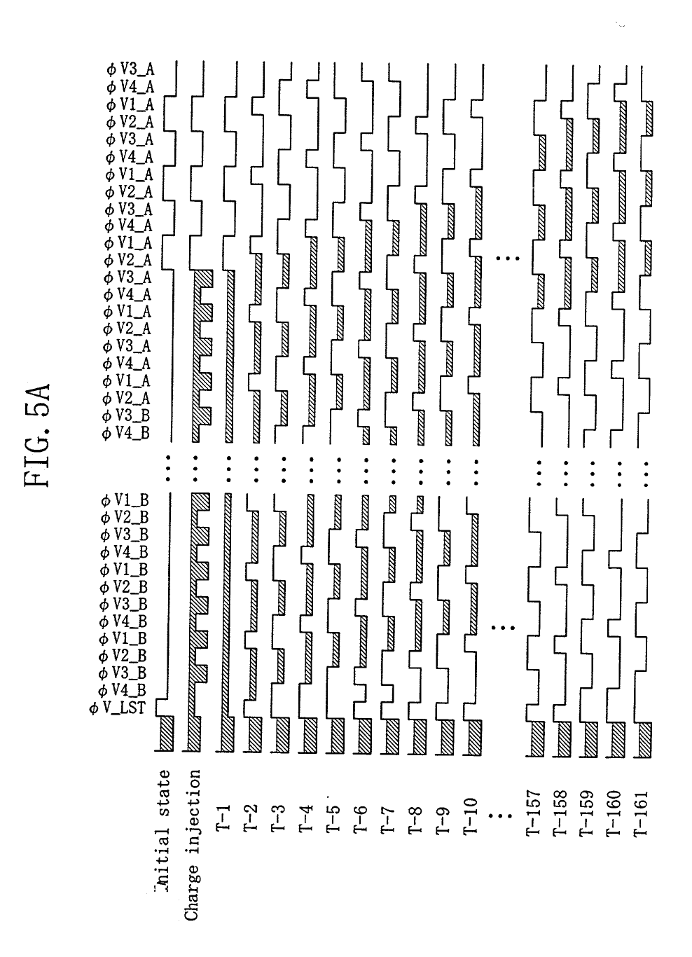

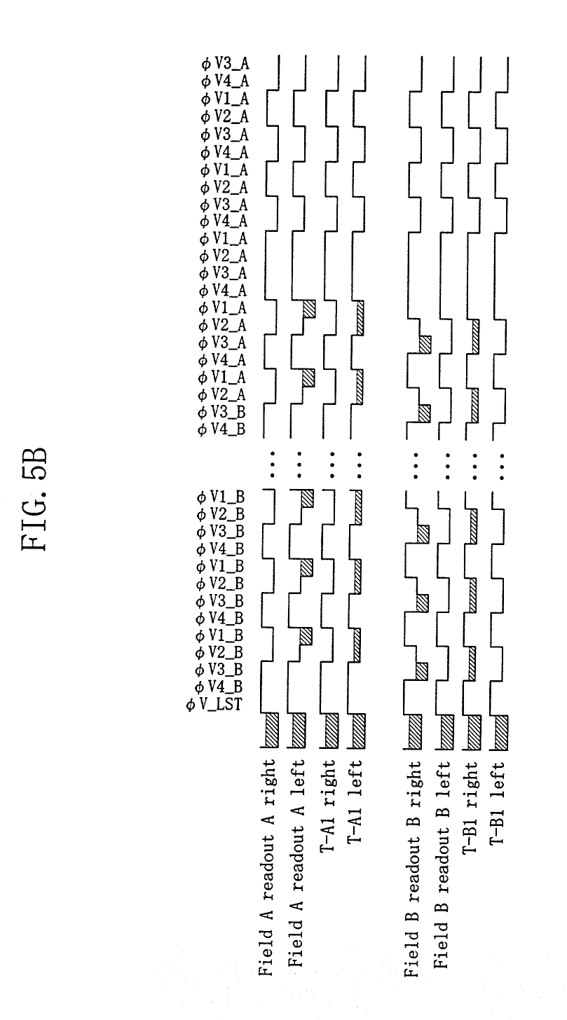

FIG. 4 is a timing chart for depicting a method of generating a marker signal in the solid-state image pickup device 100 of FIG. 1. FIGS. 5A and 5B are potential diagrams of the vertical CCDs 114, 115 corresponding to the timing chart of FIG. 4.

As described before, a marker signal needs to be stored in the marker charge storage portion 104. The vertical CCDS 114, 115 are driven with the four phase gates φ V4_B, φ V3_B, φ V2_B and φ V1_B, in addition to V_LST in the marker signal generation section 102, and with four phase gates φ V4_A, φ V3_A, φ V2_A and φ V1_A in the blocks A to D of the image pickup section 103. FIG. 4 shows the timings of the initial state, charge injection, sequential operation from T-1 through T-161, readout A in field A, T-A1, readout B in field B, and T-B1.

First, φ V_LST is turned on (0 V) at the timing of charge injection, to allow charge to be flown from the input source 101 into the vertical CCDs 114, 115. Simultaneously, a voltage of 15 V is applied to φ V1_B and φ V3_B to open these gates.

Because the gate voltage at the φ V_LST is sufficiently low with respect to the input source 101, signal charge flows from the input source 101 into the marker charge storage portion 104 via the vertical CCDs 114, 115, and thus the same potential is attained at the input source 101 and the marker charge storage portion 104. In other words, the stored charge amount in the marker charge storage portion 104 is controlled by the potential at the input source 101. Subsequently, at the timing of T-1, the readout gates φ V1_B and φ V3_B are closed, and the gate φ V_LST is turned off (−8 V). At the timings of T-1 to T-161, pulses of LOW (−8 V) and HIGH (0 V) are sequentially applied, so that the charge is transferred from the marker signal generation section 102 to the image pickup section 103, sweeping out charge in the portion of the vertical CCDs 114, 115 adjacent to the marker charge storage portion 104. A sequence of potential change with time is shown in T-1 through T-161 in FIG. 5A. By the process described above, a marker signal is prepared in the marker charge storage portion 104.

The marker signal stored in the marker charge storage portion 104 is read into the vertical CCD 114 on the left at the timing of readout A with φ V1_B in field A, and into the vertical CCD 115 on the right at the timing of readout B with φ V3_B in field B. As a result, the marker signal having the same charge amount is read from block A on the left in field A and from block B on the right in field B.

In the above description, the three-layer polysilicon gates for transfer of the marker signal were used for the vertical CCDs 114, 115. Alternatively, each electrode of the vertical CCDs may be contacted individually. Otherwise, the number of polysilicon layers may be increased or decreased. No problem will occur by these alternative configurations.

The period of the timing at which the signal is read into the left or right vertical CCD 114, 115 may be every frame or every field. Although four-phase clock was used in the above description, the number of phases of the readout gates may be increased, to enable operation of four readout gates for two vertically-adjacent pixels at individual timings (six-phase driving). In this case, also, it is possible to read the marker signal into the right and left blocks alternately every horizontal line.

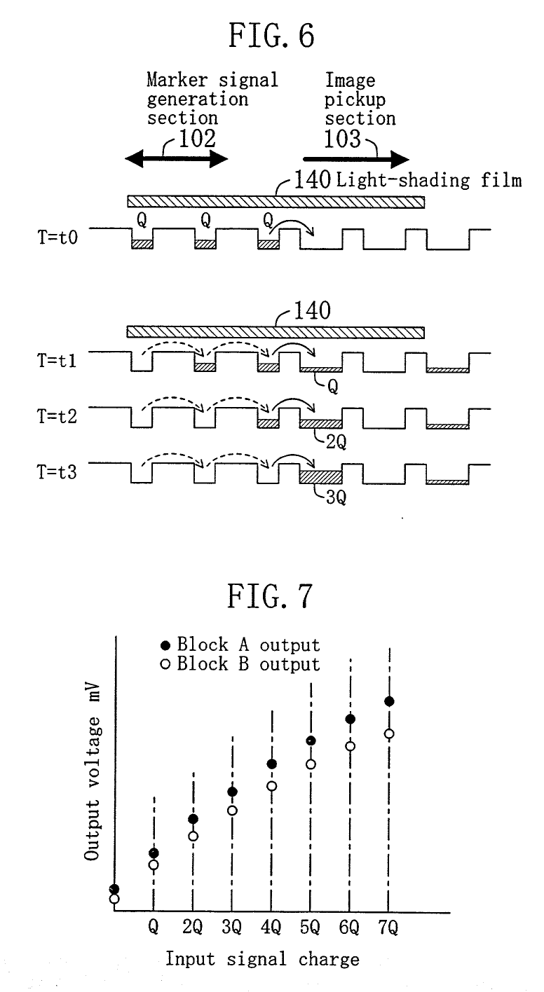

FIG. 6 illustrates a method of adding a plurality of marker signals each having a unit charge amount in the vertical CCDs 114, 115 of the solid-state image pickup device 100 of FIG. 1. In the illustrated example, a plurality of marker signals are generated while the input source potential is kept constant. More specifically, marker signals are generated using charge transfer packets created in the portion of the vertical CCDs 114, 115 in the marker signal generation section 102, and added together in the vertical CCDs 114, 115 at the boundary between the blocks of the image pickup section 103. In this way, a plurality of marker signals can be obtained at one time. This operation can be realized with only the vertical CCDs 114, 115 requiring no involvement of the marker charge storage portion 104 described above. However, to generate marker signals better in uniformity among the blocks, it is desirable to store charge in the marker charge storage portion 104 temporarily and execute addition as shown in FIG. 6 when the charge is read out.

As shown in FIG. 1, in each vertical CCD (114, 115, for example), the four phase gates φ V4_B, φ V3_B, φ V2_B and φ V1_B are used in the marker signal generation section 102, the four phase gates φ V4_A, φ V3_A, φ V2_A and φ V1_A are used in the image pickup section 103, and the independent gate φ V_LST is used at a position between the input source 101 and the marker signal generation section 102. As shown in FIG. 6, in each block, potential-controlled signal charge is allowed to flow from the input source 101 located upstream of the vertical CCDs 114, 115 into the vertical CCDs 114, 115. FIG. 6 illustrates how marker signals Q, Q and Q carried independently, shown at T=t0, are added at the boundary between the marker generation section 102 and the image pickup section 103 as shown at timings T=t1 to t3, to generate Q, 2Q and 3Q at the respective timings. Note that the marker signal generation section 102 and the portion of the image pickup section 103 other than PDs are covered with a metal light-shading film 140.

FIG. 7 is an output characteristic diagram of a plurality of marker signals generated in the manner shown in FIG. 6. By sequentially outputting the marker signals Q, 2Q, 3Q, . . . and 7Q independently, it is possible to output a plurality of marker signals as shown in FIG. 7, in which black dots represent block A outputs while white dots represent block B outputs. Obviously, these marker signals may be generated in one field or over several fields. The addition may be executed during charge transfer from the vertical CCDs to the horizontal CCDS.

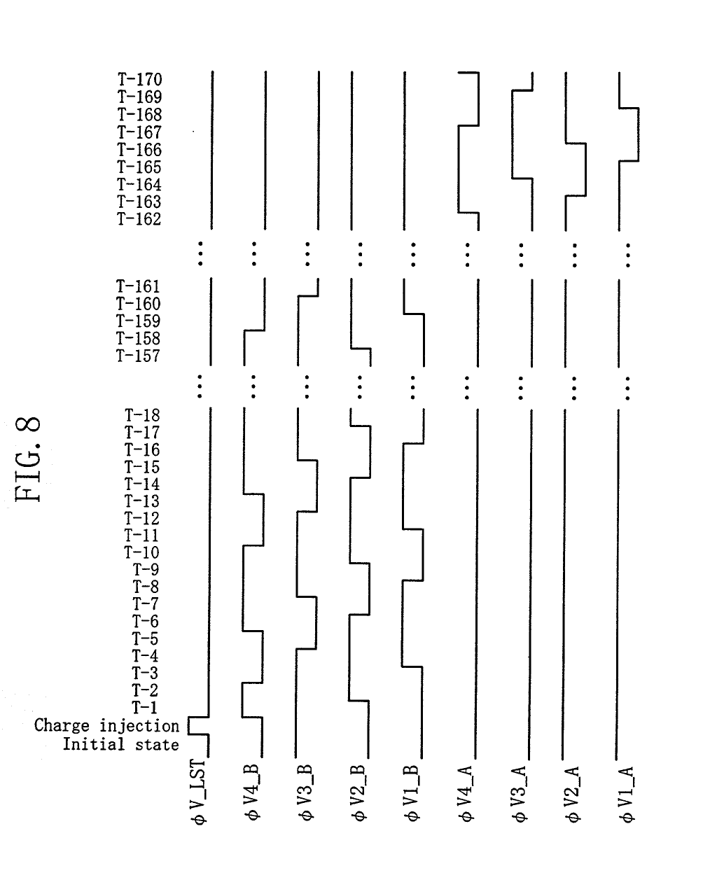

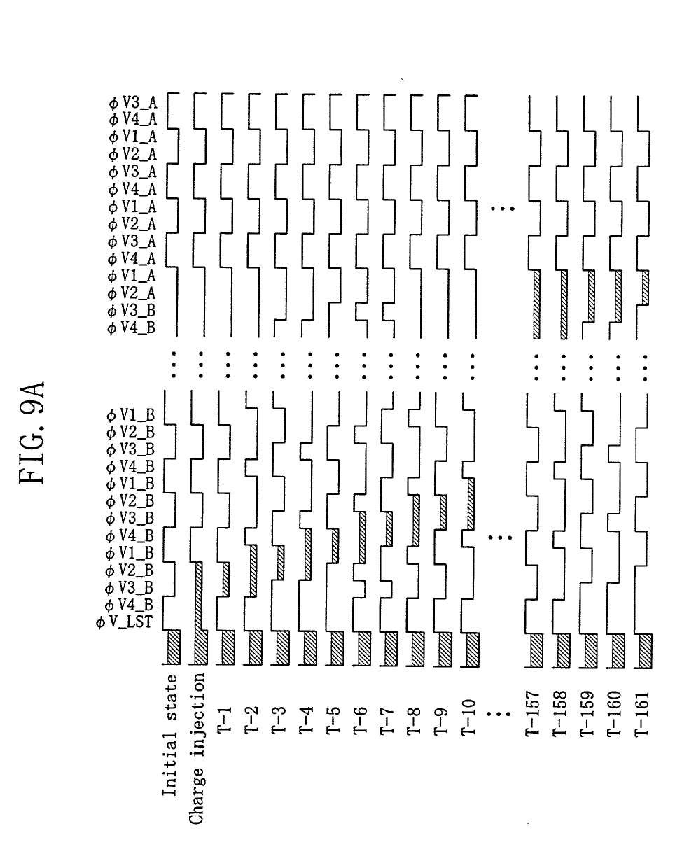

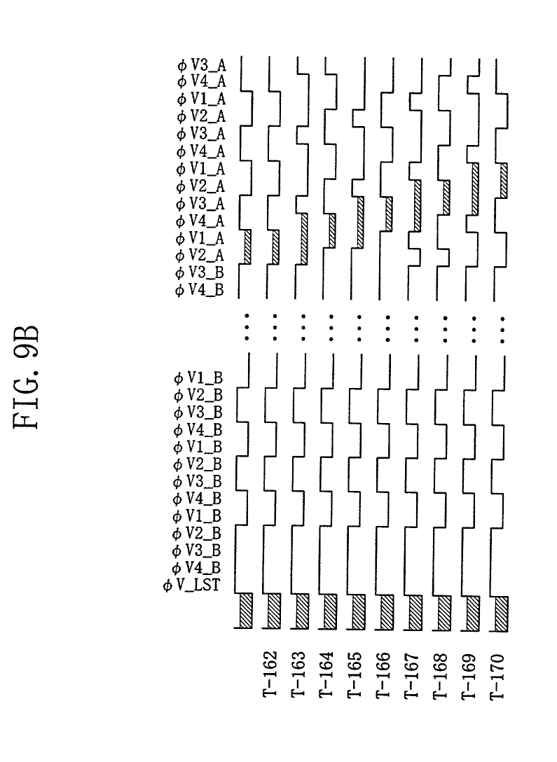

FIG. 8 is a timing chart for depicting a method of generating a marker signal using the addition method shown in FIG. 6. FIGS. 9A and 9B are potential diagrams of the vertical CCDs 114, 115 corresponding to the timing chart of FIG. 8. In this method, addition of marker signals is executed at the boundary between the marker signal generation section 102 and the image pickup section 103.

First, generation of Q will be described with reference to FIG. 8. The operation in the marker signal generation section 102 is shown by the initial state, charge injection and sequential operation from T-1 through T-161. During this operation, the portions of the vertical CCDs 114, 115 in the blocks of the image pickup section 103 such as blocks A and B remain at rest. On the contrary, during subsequent sequential operation from T-162 through T-170, the operation in the marker signal generation section 102 is halted, and the vertical CCDs 114, 115 of block A and B, for example, of the image pickup section 103 start transfer operation.

In the above operation, if the series of operation including the initial state, charge injection and sequential operation from T-1 through T-161 is performed twice while the operation from T-162 though T-170 is performed once, the marker signal 2Q can be generated. If it is performed three times, the marker signal 3Q can be generated.

The timing period for the above operation may be every frame or every field. Although four-phase clock was used in the above description, the number of phases of the readout gates may be increased, to allow operation of four readout gates for two vertically-adjacent pixels at individual timings (six-phase driving). In this case, also, it is possible to read the marker signal into the right and left blocks alternately every horizontal line.

Alternatively, the following is also possible. Marker signals, the number of which is equal to the number of the capacitors (marker charge storage portions) 104, are generated in advance using the capacitors 104 as those shown in FIGS. 3A to 3C. Once a signal charge packet sequentially transferred in the vertical CCDs 114, 115 reaches a readout position, a marker signal is read into the packet from the capacitor 104. The marker signal is then transferred to the second capacitor position by the vertical CCDs 114, 115, where a marker signal held at the second capacitor position is also read into the packet in addition to the first marker signal. In this way, the marker signals stored in the capacitors 104 at different positions in the vertical direction can be read and added together in sequence.

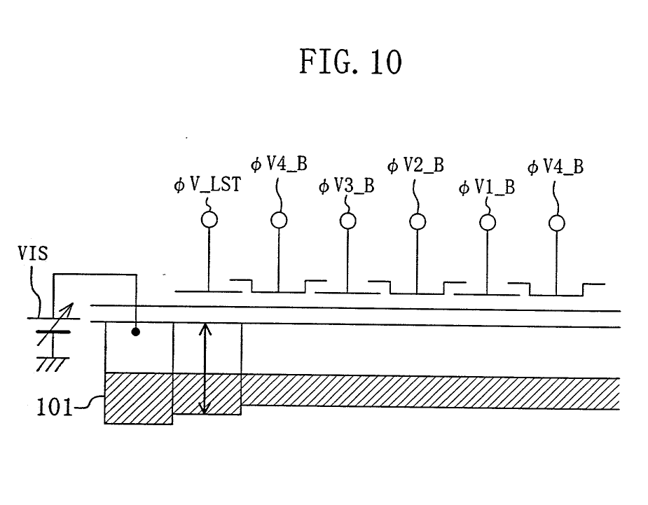

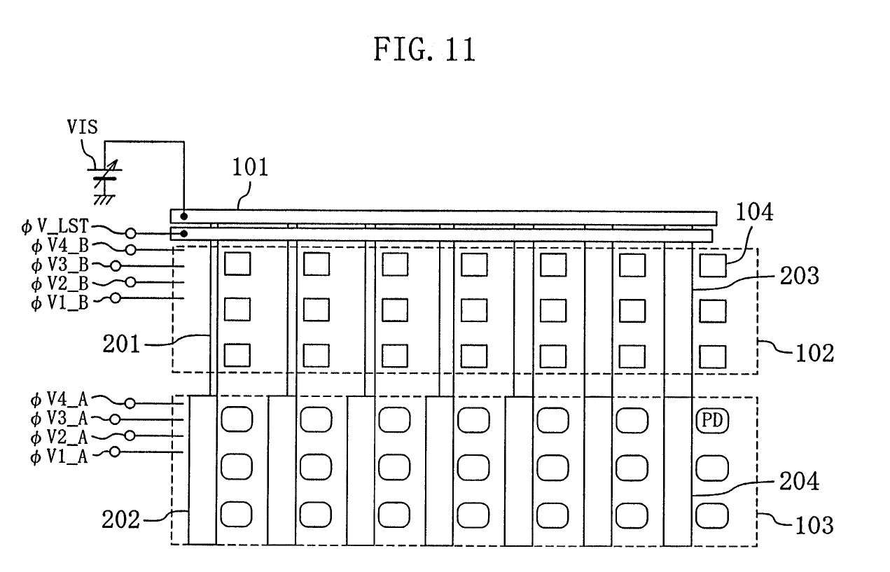

FIG. 10 illustrates that the charge amount of a marker signal in the vertical CCDs 114, 115 can be controlled by changing the potential at the input source 101 in FIG. 1. More specifically, FIG. 10 shows the potential at the input source 101 and the potentials under respective gates in the vertical CCDs 114, 115 connected to the input source 101 obtained when all of φ V4_B, φ V3_B, φ V2_B and φ V1_B are made HIGH (0 V) during the charge injection shown in FIG. 5A or 9A. If a voltage applied to φ V_LST is sufficiently large and the channel potential under this gate thereof is greater than the channel potentials under φ V4_B, V3_B, φ V2_B and φ V1_B, charge under theφ V4_B, φ V3_B, φ V2_B and φ V1_B can be controlled using the potential VIS at the input source 101, and thus the sum of charge generated in the vertical CCDs 114, 115 can be controlled arbitrarily. By combining the marker signal addition method described above with this VIS control shown in FIG. 10, it is possible to handle a number of marker signals different in magnitude more greatly, and this enables finer calibration of the input/output characteristics.

FIG. 11 illustrates a configuration adopted to generate a plurality of marker signals having different charge amounts simultaneously at the boundary between the marker signal generation section 102 and the image pickup section 103 in a block shown in FIG. 1. In this illustration, there are shown three pixels in each of the marker signal generation section 102 and the image pickup section 103 in the vertical direction and seven pixels in the horizontal direction for convenience. The number of pixels is not limited to this.

As shown in FIG. 11, a vertical CCD 201 in the marker signal generation section 102 and a vertical CCD 202 in the image pickup section 103 are coupled with each other, and a vertical CCD 203 in the marker signal generation section 102 and a vertical CCD 204 in the image pickup section 103 are coupled with each other, to enable transfer of marker signals from the marker signal generation section 102 to the image pickup section 103. In the marker signal generation section 102, the width of the vertical CCDs 201, 203 is changed in stages in the horizontal direction. The width of the vertical CCDs 202, 204 of the image pickup section 103, as the addition part, is made larger than that of the vertical CCDs 201, 203 of the marker signal generation section 102. This prevents occurrence of transfer degradation in the vertical direction and thus enables simultaneous generation of a plurality of marker signals having different charge amounts. To state specifically, the width of the vertical CCDs 201, 203 in the marker signal generation section 102 is increased from 0.45 μm up to 1.4 μm. With the above configuration, seven different marker signals can be read out when one horizontal line including marker signals is read. Further, by combining this configuration with the methods described above and increasing the number of packets used for addition at the boundary with the image pickup section 103 to two, three, or the like in the vertical direction, the number of different charge amounts can be increased twofold, threefold, or the like. This enables generation of marker signals finer than those shown in FIG. 7.

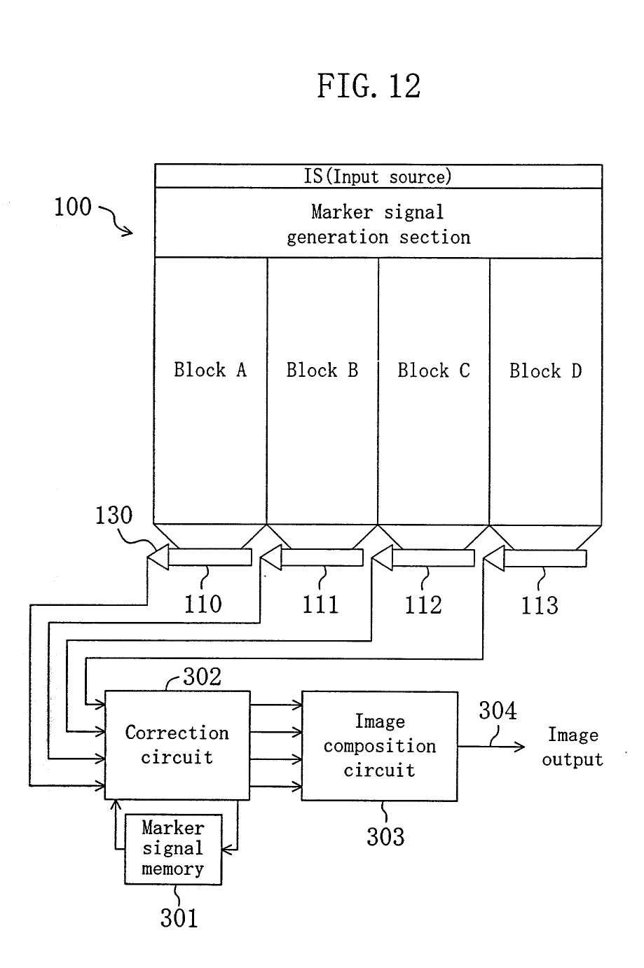

FIG. 12 illustrates the entire configuration of the solid-state image pickup apparatus of the present invention. Although the image pickup section of the image pickup device 100 is partitioned into four blocks in the illustrated example, the number of blocks is not limited to this.

An exemplary method of correction of signals from blocks A and B will be described as follows. Marker signals output from the horizontal CCDs 110, 111 via the readout amplifiers 130 are stored in a table (not shown) provided in a marker signal memory 301, and subjected to correction of signal variation caused by inter-block variation in amplifier characteristics by a correction circuit 302. Thereafter, from the corrected signals, one image is reproduced by an image composition circuit 303 and output (image output 304).

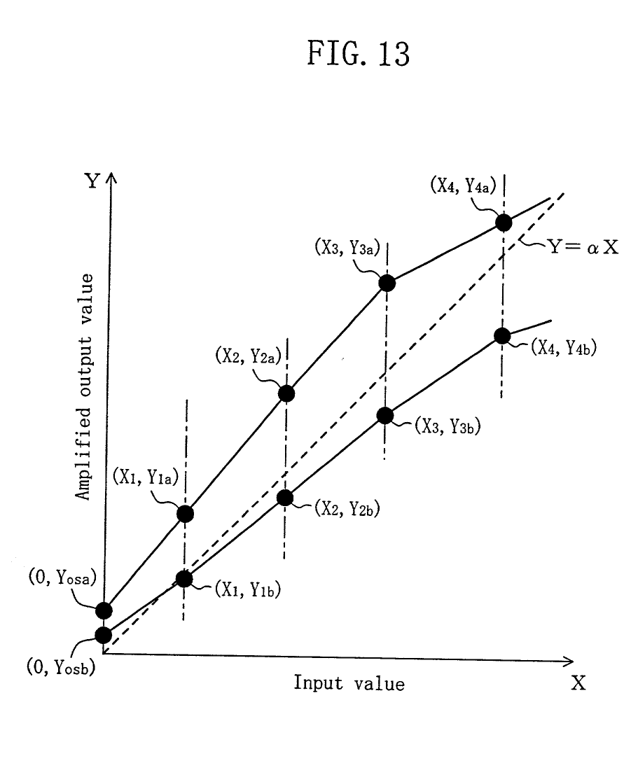

FIG. 13 shows a method of correcting the outputs of the readout amplifiers 130 of the solid-state image pickup apparatus of FIG. 12. In the correction circuit 302, the input/output characteristics are approximated using part or the entire of the following correction expressions, and in this way, the characteristics of the four outputs are matched with each other. Hereinafter, the case of providing four correction segments for an input range as shown in FIG. 13 will be described. Note however that the number of correction segments and the correction expressions for each segment are not limited to those described herein.

As marker signals in the respective blocks represented by an input value X and an amplified output value Y, (0, Yₒₛₐ), (X₁, Y₁ₐ), (X₂, Y₂ₐ), (X₃, Y₃ₐ) and (X₄, Y₄ₐ) are stored in a table (not shown) in the marker signal memory 301 for block A, and (0, Y_{osb}), (X₁, Y_{1b}), (X₂, Y_{2b}), (X₃, Y_{3b}) and (X₄, Y_{4b}) are stored for block B. The values X₁, X₂, X₃ and X₄ may be the charge amounts or the voltages actually measured, or arbitrary values conforming to these values. The following correction is performed for the image signals output from the horizontal CCDs 110 to 113.

The output Y from block A is subjected to correction by the correction circuit 302 as follows:

in segment 0≦Y<Y₁ₐ,

(Y−Yₒₛₐ)×{X₁/(Y₁ₐ−Yₒₛₐ)}×α;

in segment Y₁ₐ≦Y<Y₂ₐ,

(Y−Y₁ₐ)×{(X₂−X₁)/(Y₂ₐ−Y₁ₐ)}×α+αX₁;

in segment Y₂ₐ≦Y<Y₃ₐ,

(Y−Y₂ₐ)×{(X₃−X₂)/(Y₃ₐ−Y₂ₐ)}×α+αX₂; and

in segment Y₃ₐ≦Y<Y₄ₐ,

(Y−Y₃ₐ)×{(X₄−X₃)/(Y₄ₐ−Y₃ₐ)}×α+αX₃.

By the above correction, the output Y from block A roughly satisfies Y=αx.

The output Y from block B is subjected to correction by the correction circuit 302 as follows:

in segment 0≦Y<Y_{1b},

(Y−Y_{osb})×{X₁/(Y_{1b}−Y_{osb})}×α;

in segment Y_{1b}≦Y<Y_{2b},

(Y−Y_{1b})×{(X₂−X₁)/(Y_{2b}−Y_{1b})}×α+αX₁;

in segment Y_{2b}≦Y<Y_{3b},

(Y−Y_{2b})×{(X₃−X₂)/(Y_{3b}−Y_{2b})}×α+αX₂; and

in segment Y_{3b}≦Y<Y_{4b},

(Y−Y_{3b})×{(X₄−X₃)/(Y_{4b}−Y_{3b})}×α+αX₃.

By the above correction, the output Y from block B also roughly satisfies Y=αX.

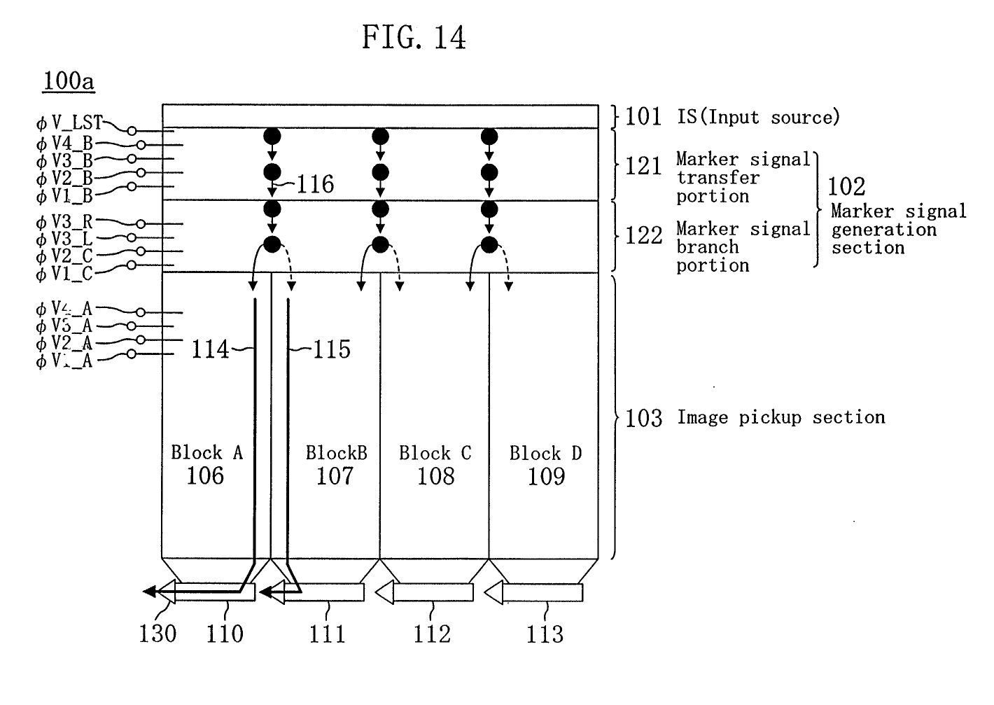

FIG. 14 illustrates another configuration of the image pickup device of the solid-state image pickup apparatus of the present invention. In the solid-state image pickup device 100 of FIG. 1, the charge flown from the input source 101 into the vertical CCDs 114, 115 of the marker signal generation section 102 is temporarily stored in the marker charge storage portion 104 provided downstream. Marker signal charge stored in the marker charge storage portion 104 is then flown out again into the vertical CCDs 114, 115 every field or every frame, to be read into the left and right blocks A and B alternately. The readout from the marker charge storage portion 104 into the vertical CCDs 114, 115 is acceptable from the aspect of transfer efficiency. When the gates φ V1_B and φ V3_B of the vertical CCDs 114, 115 are turned off after charge has been flown into the marker charge storage portion 104, the charge under these gates is distributed into the marker charge storage portion 104 and the vertical CCDs 114, 115. At this time, if the gate area is large, the variation amount is large. In addition, charge tends to be left behind in the vertical CCDs 114, 115. A solid-state image pickup device 100a of FIG. 14 is configured to improve the problem at the time of turning off the gates of the vertical CCDs 114, 115 although the number of driving pulses required increases.

To state specifically, the marker signal generation section 102 of the solid-state image pickup apparatus 100a of FIG. 14 is essentially composed of a marker signal transfer portion 121 and a marker signal branch portion 122, so that a marker signal is flown unidirectionally from the input source 101 to the vertical CCDs 114, 115 in the marker signal branch portion 122 via a vertical CCD 116 in the marker signal transfer portion 121. This solid-state image pickup apparatus 100a also adopts four-block parallel-output configuration using CCDs as shown in FIG. 1. The difference from the configuration of FIG. 1 is that the marker signal transfer portion 121, namely, the vertical CCD 116 in the illustrated example, is provided dedicatedly for transfer of charge from the input source 101 to the marker signal branch portion 122. The marker signal transfer portion 121 is driven by four phase gates φ V4_B, φ V3_B, φ V2_B and φ V1_B, in addition to gate φ V_LST, the marker signal branch portion 122 is driven by four phase gates φ V3_R, φ V3_L, φ V2_C and φ V1_C, and blocks A to D of the image pickup section 103 are driven by four phase gates φ V4_A, φ V3_A, φ V2_A and φ V1_A.

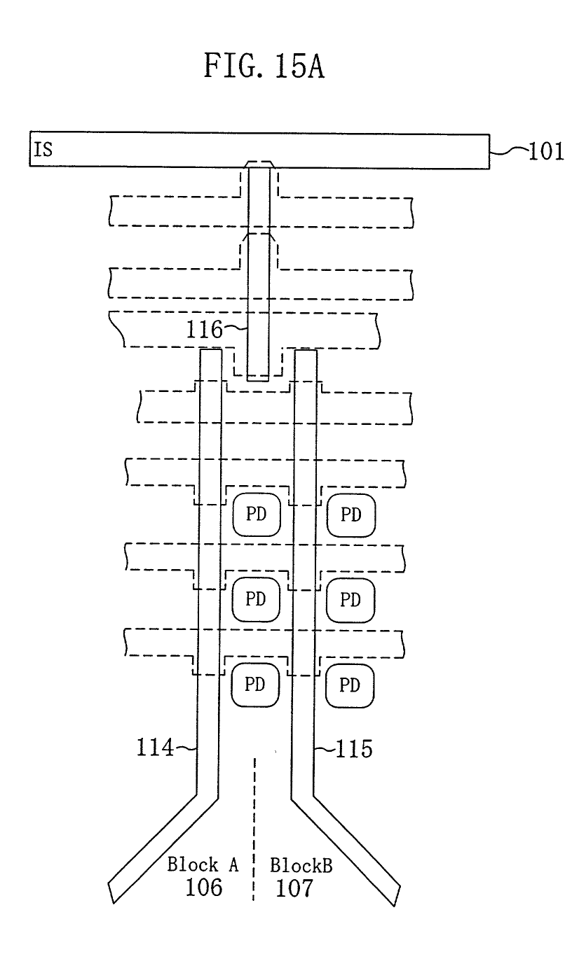

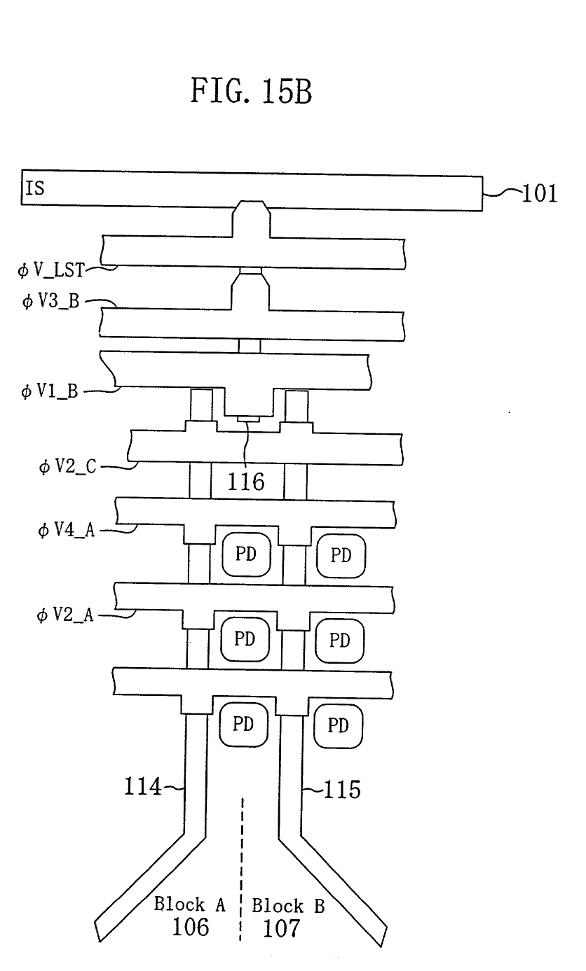

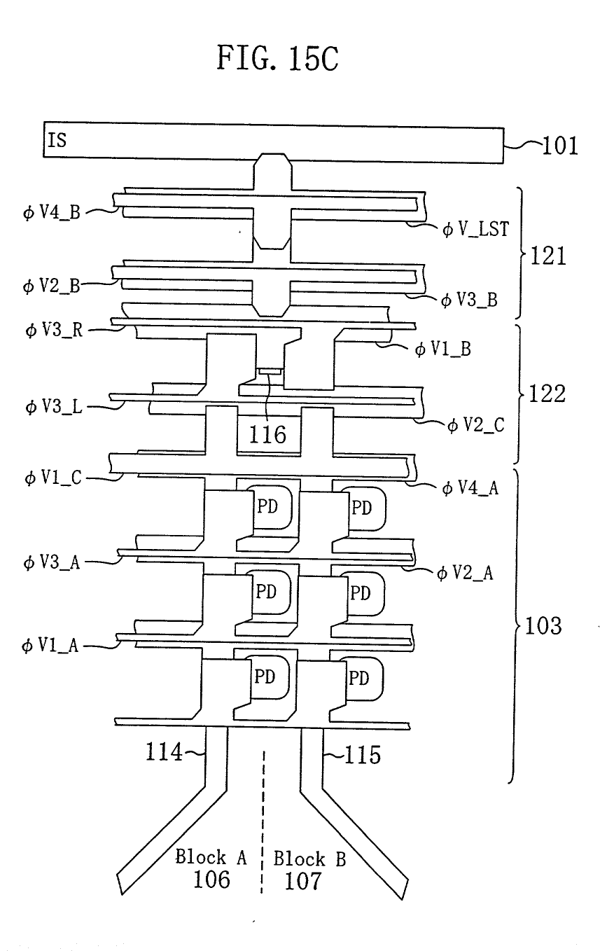

FIGS. 15A to 15C illustrate a process of formation of the three vertical CCDs 114 to 116 in FIG. 14. FIG. 15A illustrates impurity injection portions for formation of the vertical CCDs 114 to 116. FIG. 15B illustrates multi-phase gates formed of polysilicon on the impurity injection portions. FIG. 15C illustrates other multi-phase gates formed of polysilicon on the already-formed multi-phase gates. The gate φ V_LST is a gate for charge injection from the input source 101 into the vertical CCD 116. The gates φ V3_L and φ V3_R constitute branches from the vertical CCD 116 to the left vertical CCD 114 and the right vertical CCD 115, respectively. Although not shown, the marker signal transfer portion 121 and the marker signal branch portion 122 are covered with a metal light-shading film at the top to prevent influence of incident light.

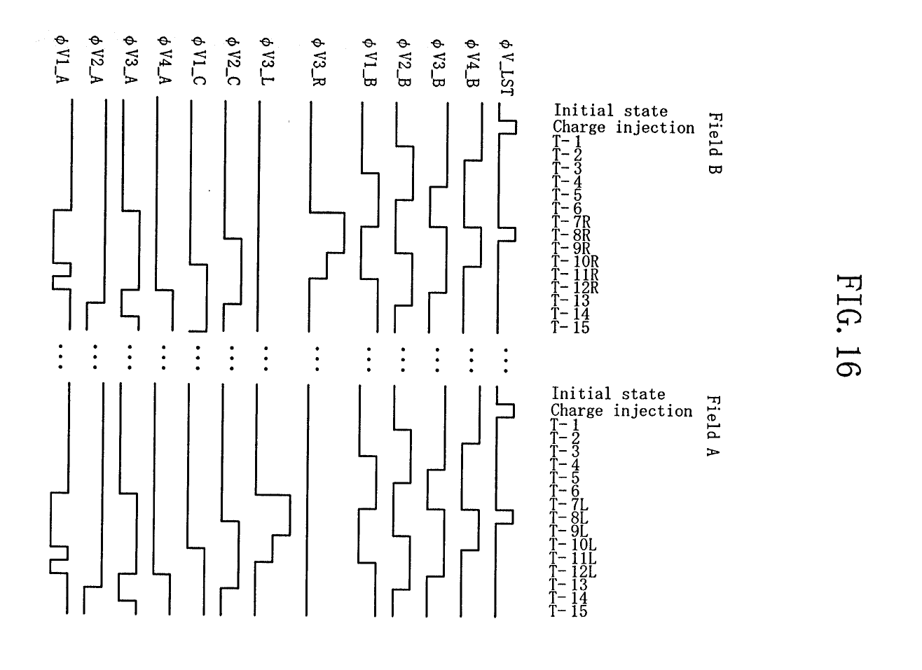

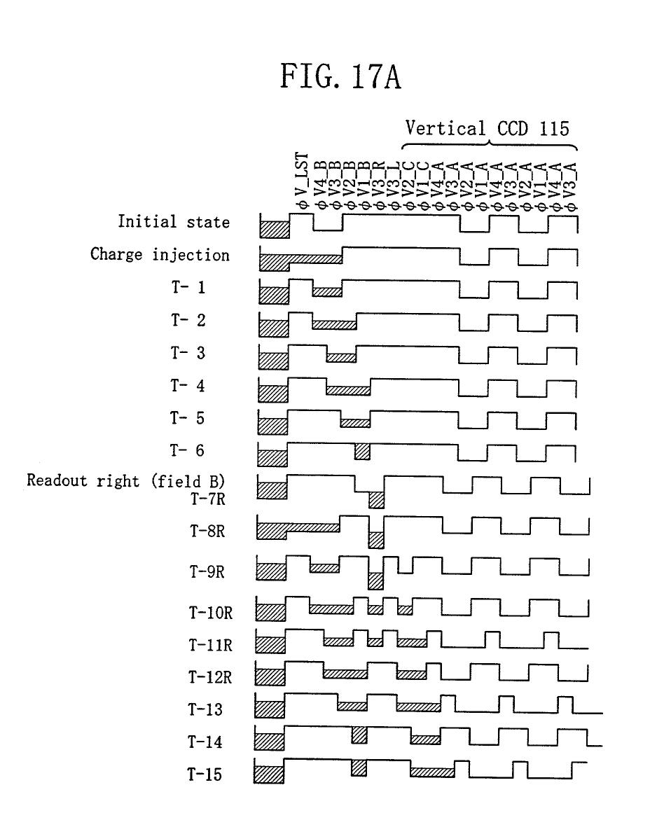

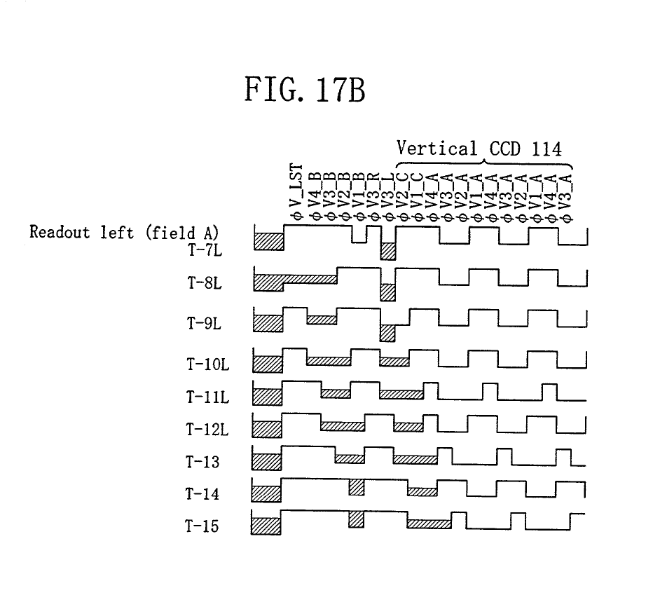

FIG. 16 is a timing chart for depicting a method of generating a marker signal in the solid-state image pickup device 100a of FIG. 14. FIGS. 17A and 17B are potential diagrams of the vertical CCDs 114 to 116 corresponding to the timing chart of FIG. 16.

Hereinafter, the operation of introducing a marker signal into the vertical CCD 116 from the input source 101 and distributing the signal to the two vertical CCDs 114 and 115 will be described with reference to the timing chart of FIG. 16. FIG. 16 shows the timings of the initial state, charge injection, sequential operation from T-1 through T-6, operation T-7R though T-12R for distribution to the right vertical CCD 115 in field B, subsequent normal transfer T-13 to T-15, operation T-7L though T-12L for distribution to the left vertical CCD 114 in field A, and subsequent normal transfer T-13 to T-15.

First, φ V_LST is turned on (0 V) at the timing of charge injection, to allow charge to be flown from the input source 101 into the vertical CCD 116. At this time, gates φ V4_B and φ V3_B are also turned on (0 V). At the timing of T-1, φ V_LST is turned off (−8 V). At the timings of T-2 to T-6, pulses of LOW (−8 V) and HIGH (0 V) are sequentially applied to the gates φ V4_B through φ V1_B, so that marker signal charge is transferred to the marker signal branch section 122.

In the marker signal branch portion 122, the marker signal charge is read into the right vertical CCD 115 by applying a readout voltage (15 V) to φ V3_R during T-7R through T-9R in field B. The read marker signal charge is transferred to the upstream portion of the image pickup section 103 during T-13 through T-15. Thereafter, known vertical CCD charge transfer is performed. In field A, the marker signal charge is read into the left vertical CCD 114 by use of φ V3_L at the timings T-7L through T-9L. Further, transfer is performed at the timings T-10L through T-12L. The subsequent operation is the same as in field B.

As a result of the series of potential change with time, the marker signal charge transferred in the marker signal transfer portion 121 is read from block B on the right in field B and from block A on the left in field A as marker signals having the same charge amount.

In the above description, it was assumed that two-layer polysilicon gates for transfer of marker signals were used for the vertical CCDs 114 to 116. Alternatively, each electrode of the vertical CCDs may be contacted individually. Otherwise, the number of polysilicon layers may be increased or decreased. No problem will occur by these alternative configurations.

The period of the timing at which the signal is read into the left or right vertical CCD 114, 115 may be every frame, every field or a period shorter than a field. Although the 12-phase clock was used in the above description, the number of phases may be decreased by sharing the gate electrode, and in this case, also, it is possible to distribute the marker signal to the right and left blocks for alternate readout.

VIS control as shown in FIG. 10 can also be adopted for the solid-state image pickup device 100a of FIG. 14. Naturally, the solid-state image pickup device 100 in FIG. 12 may be replaced with the solid-state image pickup device 110aof FIG. 14.

In any of the configurations of FIGS. 1, 10, 11 and 14, the input source 101 may be replaced with a horizontal CCD, and a small-area input source may be provided separately for supply of a required amount of charge to the horizontal CCD.

While the present invention has been described in a preferred embodiment, it will be apparent to those skilled in the art that the disclosed invention may be modified in numerous ways and may assume many embodiments other than that specifically set out and described above. Accordingly, it is intended by the appended claims to cover all modifications of the invention which fall within the true spirit and scope of the invention.

What is claimed is:

1. A solid-state image pickup apparatus permitting parallel readout comprising an image pickup section partitioned into blocks and a readout amplifier for each block, the apparatus further comprising:
a marker signal source for supplying a required amount of charge; and
a marker signal generation section for generating marker signals having a same charge amount to be sent into two adjacent blocks of the image pickup section from the charge supplied from the marker signal source,
wherein each of the blocks of the image pickup section transfers the marker signal sent from the marker signal generation section so that the marker signal is read out via the readout amplifier for the block for correction of an output of the readout amplifier.

2. The apparatus of claim 1, wherein the marker signal generation section comprises:
a marker charge storage portion for storing the charge supplied from the marker signal source; and
means for generating marker signals to be sent into two adjacent blocks of the image pickup section from the charge stored in the marker charge storage portion.

3. The apparatus of claim 1, wherein the marker signal generation section comprises:
a marker signal transfer portion for transferring the charge supplied from the marker signal source as a common marker signal; and
a marker signal branch portion for sending the common marker signal transferred from the marker signal transfer portion into two adjacent blocks of the image pickup section.

4. The apparatus of claim 1, further comprising a horizontal CCD for each block coupled to the readout amplifier for each block,
wherein the image pickup section has a vertical CCD and is located between the marker signal generation section and the horizontal CCD for each block.

5. The apparatus of claim 1, wherein the marker signal generation section is shaded from light.

6. The apparatus of claim 1, further comprising means for adding a plurality of marker signals each having a unit charge amount.

7. The apparatus of claim 1, wherein the marker signal source comprises an input source for supplying an amount of charge corresponding to a given potential.

8. The apparatus of claim 7, further comprising means for changing the potential at the input source.

9. The apparatus of claim 4, wherein the marker signal generation section has a vertical CCD, and the width of the vertical CCD is equal to or less than the width of the vertical CCD of the image pickup section.

10. The apparatus of claim 1, further comprising:
a marker signal memory for recording the marker signal for each block; and
a correction circuit for correcting an image output of the readout amplifier according to the record in the marker signal memory.

11. The apparatus of claim 10, wherein the correction circuit is configured to attain nonlinear correction by performing linear conversion of the image output for each segment.

12. A method for driving a solid-state image pickup apparatus permitting parallel readout comprising an image pickup section partitioned into blocks and a readout amplifier for each block, the method comprising the steps of:
generating marker signals for correction of outputs of the readout amplifiers;
reading the generated marker signals having a same charge amount via the readout amplifiers for two adjacent blocks; and
generating another marker signal by adding a plurality of marker signals each having a unit charge amount.

13. The method of claim 12, further comprising the step of:
executing the addition of marker signals in a vertical CCD.
